(19) United States
(12) Patent Application Publication
(10) Pub. No.: US 2022/0200639 A1
(43) Pub. Date: Jun. 23, 2022

(54) CAPACITOR SUBSTITUTION IN A STACKED RESONATOR BASED ANTENNAPLEXER

(71) Applicant: SKYWORKS SOLUTIONS, INC., Irvine, CA (US)

(72) Inventors: Weimin Sun, Santa Rosa Valley, CA (US); Hai H. Ta, Thousand Oaks, CA (US); Chuan Shi, Thousand Oaks, CA (US)

(21) Appl. No.: 17/546,985

(22) Filed: Dec. 9, 2021

Related U.S. Application Data
(60) Provisional application No. 63/127,619, filed on Dec. 18, 2020.
(60) Provisional application No. 63/127,621, filed on Dec. 18, 2020.

(51) Int. Cl. H04B 1/00

(52) U.S. Cl. CPC H04B 1/0057

(57) ABSTRACT

An improved antennaplexer provides improved harmonic and intermodulation distortion (IMD) rejection. Aspects of the antennaplexer can substitute one or more of the resonators in the stacked resonator circuit with a capacitor. The introduction of the capacitor can reduce the non-linearity of the received signals. In some cases, the capacitor may be a metal-insulator-metal (MIM) capacitor. Advantageously, the combination of the stacked resonators and the capacitor substitution for a resonator improves the linearity of the antennaplexer and provides for sharper rejection of undesired signals. Thus, the wireless device can support a greater number of frequency bands and/or frequency bands that are more likely to cause harmonic interference and/or IMD distortion. In some cases, the harmonic interference or IMD interference may be reduced by up to 15 dB compared to existing filters or antennaplexers.

### INCORPORATION BY REFERENCE TO ANY PRIORITY APPLICATIONS

This application claims priority to U.S. Provisional Application No. 63/127,619, filed on Dec. 18, 2020 and titled “STACKED RESONATOR BASED ANTENNAPLEXER,” and to U.S. Provisional Application No. 63/127,621, filed on Dec. 18, 2020 and titled “CAPACITOR AND STACKED RESONATOR BASED ANTENNAPLEXER,” the disclosures of both of which are hereby incorporated by reference in their entirety for all purposes. Further, this application incorporates by reference in its entirety for all purposes U.S. application Ser. No. ______ (Attorney Docket No. SKYWRKS.1036A1), which is titled “STACKED RESONATOR BASED ANTENNAPLEXER,” and is filed on Dec. 9, 2021, the same filing date as the present application. Any and all applications for which a foreign or domestic priority claim is identified in the Application Data Sheet as filed with the present application are hereby incorporated by reference under 37 CFR 1.57.

### BACKGROUND

### Technical Field

Embodiments of this disclosure relate to acoustic wave filters.

### Description of the Related Art

An acoustic wave filter can include a plurality of acoustic resonators arranged to filter a radio frequency signal. Example acoustic wave filters include surface acoustic wave (SAW) filters and bulk acoustic wave (BAW) filters. A surface acoustic wave resonator of a surface acoustic wave filter typically includes an interdigital transductor electrode on a piezoelectric substrate. A surface acoustic wave resonator is arranged to generate a surface acoustic wave.

Acoustic wave filters can be implemented in radio frequency electronic systems. For instance, filters in a radio frequency front end of a mobile phone can include acoustic wave filters.

### SUMMARY

The systems, methods and devices of this disclosure each have several innovative aspects, no single one of which is solely responsible for all of the desirable attributes disclosed herein. Details of one or more implementations of the subject matter described in this specification are set forth in the accompanying drawings and the description below.

Certain aspects of the present disclosure relate to an antennaplexer. The antennaplexer may include a first signal path between an antenna port and a first output port. The first signal path may include a first resonator in series with a first capacitor. Further, the antennaplexer may include a first shunt path connected to the first signal path between the first resonator and the first output port. Additionally, the antennaplexer may include a second signal path between the antenna port and a second output port. The first signal path may be configured to transmit signals of a first frequency band and the second signal path may be configured to transmit signals of a second frequency band that differs from the first frequency band.

In certain implementations, the first capacitor substitutes for a second resonator. Further, the first capacitor may be a metal-insulator-metal type capacitor. Moreover, the first shunt path may include a stacked resonator including a second resonator in series with a third resonator. The first shunt path may further include a second capacitor in series with the stacked resonator. The second capacitor may substitute for a fourth resonator in series with the stacked resonator.

Further, the first signal path may include a second resonator between the first shunt path and the first output port. Moreover, the antennaplexer may further include a second shunt path connected to the first signal path between a node where the first shunt path connects to the first signal path and the first output port. Moreover, the second signal path may include an inductor-capacitor network without a resonator. The first resonator may be an acoustic wave resonator. Further, the acoustic wave resonator may be a temperature compensated surface acoustic wave device.

In some embodiments, the second signal path includes a stacked resonator including a second resonator in series with a third resonator. The antennaplexer may further include a second shunt path connected to the second signal path between the stacked resonator and the second output port. Further, the second shunt path may include a third resonator in series with an inductor. Moreover, the antennaplexer may include a third shunt path connected to the second signal path between a node where the second shunt path connects to the second signal path and the second output port. In some cases, the first frequency band may correspond to a cellular communication band and the second frequency band may correspond to a global positioning system band.

Additional aspects of the present disclosure relate to a front-end module. The front-end module may include a power amplifier module configured to amplify one or more radio frequency signals. Moreover, the front-end module may include an antennaplexer that includes a first signal path, a shunt path, and a second signal path. The first signal path may be between an antenna port and a first output port, and may include a first resonator in series with a first capacitor, the first output port in communication with the power amplifier module, the shunt path between the first resonator and the first output port, and the second signal path between the antenna port and a second output port, the first signal path configured to transmit signals of a first frequency band and the second signal path configured to transmit signals of a second frequency band.

In certain implementations, the first capacitor substitutes for a second resonator. Further, the shunt path may include a stacked resonator including a second resonator in series with a third resonator.

Yet further aspects of the present disclosure relate to a wireless device. The wireless device may include an antenna configured to transmit and receive radio frequency signals, a transceiver, and an antennaplexer between the antenna and the transceiver. The antennaplexer may include a first signal path, a shunt path, and a second signal path. The first signal path may be between an antenna port connected to the antenna and a first output port connected to the transceiver. Further, the first signal path may include a resonator in series with a first capacitor. The shunt path may be between the resonator and the first output port. The second signal path may be between the antenna port and a second output port. The first signal path may be configured to transmit signals of a first frequency band and the second signal path may be configured to transmit signals of a second frequency band.

Certain aspects of the present disclosure relate to an antennaplexer. The antennaplexer may include a first signal path between an antenna port and a first output port. The first signal path may include a first stacked resonator that may include a first resonator in series with a second resonator. The antennaplexer may further include a first shunt path connected to the first signal path between the first stacked resonator and the first output port. Moreover, the antennaplexer may include a second signal path between the antenna port and a second output port. The first signal path may be configured to transmit signals of a first frequency band and the second signal path may be configured to transmit signals of a second frequency band that differs from the first frequency band.

In some implementations, the first shunt path includes a second stacked resonator. The second stacked resonator may include at least a third resonator in series with a fourth resonator. Further, the first signal path may include a third resonator in series with the first stacked resonator. The third resonator may be connected between the first shunt path and the first output port. In some embodiments, the second signal path includes an inductor-capacitor network. In some such cases, the second signal path does not include an acoustic wave resonator.

Further, at least the first resonator may be an acoustic wave resonator. Moreover, the acoustic wave resonator may be a temperature compensated surface acoustic wave device. Additionally, the first stacked resonator may include a third resonator in series with the first resonator and the second resonator. The first stacked resonator may include a capacitor in series with the first resonator and the second resonator. In some such cases, the capacitor substitutes for a third resonator within the first signal path.

In some embodiments, the second signal path includes a second stacked resonator. The second stacked resonator may include at least a third resonator in series with a fourth resonator. Further, the antennaplexer may include a second shunt path connected to the second signal path between the second stacked resonator and the second output port. The second shunt path may include a third resonator in series with an inductor. Moreover, the first frequency band may correspond to a cellular communication band and the second frequency band may correspond to a global positioning system band.

Additional aspects of the present disclosure relate to a front-end module. The front-end module may include a power amplifier module configured to amplify one or more radio frequency signals. Moreover, the front-end module may include an antennaplexer that includes a first signal path, a first shunt path, and a second signal path. The first signal path may include a first stacked resonator between an antenna port and a first output port. The first stacked resonator may include a first resonator in series with a second resonator. The first output port may be in communication with the power amplifier module, the first shunt path may be between the first stacked resonator and the first output port, and the second signal path may be between the antenna port and a second output port. Further, the first signal path may be configured to transmit signals of a first frequency band and the second signal path may be configured to transmit signals of a second frequency band.

In certain implementations, at least the first resonator is an acoustic wave resonator. Moreover, the second signal path may include a second stacked resonator. The second stacked resonator may include at least a third resonator in series with a fourth resonator. Further, the antennaplexer may include a second shunt path between the second stacked resonator and the second output port.

Yet further aspects of the present disclosure relate to a wireless device. The wireless device may include an antenna configured to transmit and receive radio frequency signals, a transceiver, and an antennaplexer between the antenna and the transceiver. The antennaplexer may include a first signal path, a first shunt path, and a second signal path. The first signal path may include a first stacked resonator between an antenna port connected to the antenna and a first output port connected to the transceiver. The first stacked resonator may include a first resonator in series with a second resonator. The first shunt path may be between the first stacked resonator and the first output port, and the second signal path may be between the antenna port and a second output port. The first signal path may be configured to transmit signals of a first frequency band and the second signal path may be configured to transmit signals of a second frequency band.

In certain implementations, the second signal path includes a second stacked resonator. This second stacked resonator may include at least a third resonator in series with a fourth resonator. Further, the antennaplexer may include a second shunt path between the second stacked resonator and the second output port.

### BRIEF DESCRIPTION OF THE DRAWINGS

Throughout the drawings, reference numbers are re-used to indicate correspondence between referenced elements. The drawings are provided to illustrate embodiments of the inventive subject matter described herein and not to limit the scope thereof.

FIG. 1 illustrates a block diagram of an aspect of a wireless device.

FIG. 2 illustrates a block diagram of a portion of a wireless device with an antennaplexer.

FIG. 3 illustrates a block diagram of an antennaplexer in accordance with certain aspects of the present disclosure.

FIG. 4 illustrates a circuit diagram of an antennaplexer in accordance with certain aspects of the present disclosure.

FIG. 5 illustrates a circuit diagram of an alternative antennaplexer in accordance with certain aspects of the present disclosure.

FIG. 6 is a diagram of a cross section of a temperature compensated SAW resonator according to an embodiment.

FIG. 7 presents test data comparing the antennaplexers of FIG. 4 and FIG. 5.

FIG. 8 presents both test data and simulation data comparing the harmonic rejection between the antennaplexers of FIG. 4 and FIG. 5.

FIG. 9A presents both test data and simulation data comparing the intermodulation rejection between the antennaplexers of FIG. 4 and FIG. 5.

FIG. 9B illustrates a pair of example second-order intermodulation distortion cases used to generate the test data of FIG. 9A.

FIG. 9C illustrates a pair of example third-order intermodulation distortion cases used to generate the test data of FIG. 9A.

### DETAILED DESCRIPTION

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

In this description, references to “an embodiment,” “one embodiment,” or the like, mean that the particular feature, function, structure or characteristic being described is included in at least one embodiment of the technique introduced herein. Occurrences of such phrases in this specification do not necessarily all refer to the same embodiment. On the other hand, the embodiments referred to are also not necessarily mutually exclusive.

### Introduction

Wireless devices typically receive multiple wireless signals of different frequency bands. In some cases, a wireless device may be capable of processing signals of a single frequency band or set of frequency bands. In other cases, the wireless device may be capable of processing signals of different frequency bands or sets of frequency bands. In some cases, the different frequency bands are associated with different technologies, communication standards, or features of the wireless device. For example, a wireless device may be capable of communication using Wi-Fi technology and cellular technology (e.g., 4G, 4G LTE, 5G, and the like). Further, a wireless device may include geolocation services, such as those provided by or enabled by the Global Positioning System (GPS).

A front-end module may process signals received by a wireless device before providing the processed signals to a receiver or transceiver within the wireless device. Processing the received signals may include filtering out undesired signals. These undesired signals may be associated with frequency bands not supported by the particular receiver. In some cases, some of the undesired signals may be associated with frequency bands supported by other receivers within the wireless device. Thus, the undesired signals may be noise for a particular receiver, but may be the target or desired signals for another receiver within the wireless device.

Regardless of whether the undesired signals are general noise or interference, or are communication signals to be received by another front-end module or receiver within the wireless device, the undesired signals may be problematic for a particular receiver because the undesired signals may mask the desired signal or desensitize the front-end module or receiver due to intermodulation and/or harmonic interference. For example, a GPS front-end module may be configured to process L1 GPS signals (e.g., GPS signals of approximately 1.575 GHz). However, the GPS front-end module may also receive 2.4 GHz Wi-Fi signals and 800 MHz Long-Term Evolution (LTE) signals (or band 13 LTE signals). The intermodulation of the 2.4 GHz Wi-Fi signals with the 800 MHz LTE signals is approximately 1.6 GHz. The intermodulation frequency in this example is close enough to the frequency of the GPS signal to mask the GPS signal or to cause noise within the GPS signal. Further, the second harmonic of the 800 MHz LTE signal is also approximately 1.6 GHz, which may further cause interference with identifying the GPS signal. For example, the LTE Band 13 is 777-787 MHz and has a second harmonic of 1554-1574 MHz, and the LTE Band 14 is 788-798 MHz and has a second harmonic of 1576-1596 MHz. In other words, both Band 13 and 14 have second harmonics that are approximately equal to or very close to the GPS frequency. Thus, in some cases, harmonic interference may mask a received GPS signal or otherwise introduce noise that causes interference in the signal.

Further, in some cases, interference may also be caused by intermodulation (IMD) interference as described above. In some cases, the majority of the interference may be caused by second order intermodulation (IM2) products. For example, an LTE Band 8 signal of 915 MHz and a 2.4 GHz WiFi signal of 2472 MHz may result in a second order intermodulation product of 1557 MHz, which is close to the GPS frequency band of 1.575 GHz. As another example, an LTE Band 26 signal of 840 MHz and a 2.4 GHz WiFi signal of 2415 MHz may result in a second order intermodulation product of 1575 MHz, which is equal to the GPS frequency band of 1.575 GHz. Thus, IM2 products may interfere or otherwise introduce noise that reduces the capability of a receiver to distinguish GPS signal.

As mentioned above, some wireless devices may be configured to support multiple receivers or multiple frequency bands. Further, in some cases, a wireless device may support carrier aggregation, or the aggregation of multiple frequency bands as part of a single transmission signal or receive signal. Regardless of whether a received signal is part of a carrier aggregated signal or whether multiple frequency bands are received due to an antenna supporting multiple frequency bands, it is often desirable to split the signals into constituted frequencies or frequency bands. For example, often, different frequency bands are supported by difference receivers and thus, are split so as to be provided to the supported receiver.

To split the signals, a filter may be used that can propagate or transmit a signal to a particular receive path and/or to a particular receiver. This filter may filter out undesired signals such as undesired harmonics or intermodulation products. Further, the filter may divide a signal into constituted frequency bands and propagate the different frequency bands to particular receivers or receive paths. The filter may be an acoustic filter and can sometimes be referred to as an “antennaplexer” or an “antenna-plexer.”

As wireless devices support more frequency bands due, for example, to new technologies and/or the support of more features, the previously described problems of harmonic interference and intermodulation distortion increases. The increased noise and distortion impacts the quality of wireless communication and the speed of communication. Existing antennaplexers have insufficient noise suppression and interference reduction for many applications, including 5G communication.

The present disclosure introduces an improved antennaplexer that is capable of splitting transmission signals and received signals into different frequency bands and providing the frequency bands to the front-end module or receiver that supports the frequency bands. Further, the improved antennaplexer provides improved harmonic and intermodulation distortion (IMD) rejection. In some cases, the improved antennaplexer can provide improved second and third order IMD rejection. The antennaplexer of the present disclosure uses stacked or split resonators to reduce harmonic interference. The stacked resonators may function similar to a voltage divider. By dividing the signal across the resonators of the stacked resonators, it is easier to reject the undesired harmonics for each of the reduced signals, thereby improving harmonic rejection. By splitting the resonators of the antennaplexer, a square root effect may be achieved for the harmonic distortion and an improvement of up to 6 dB can be obtained. Further, an improvement in the third harmonic of up to 9× can be achieved. Moreover, the division of the signal over the stacked resonators may improve the linearity of the filtered signal.

Further, aspects of the antennaplexer can substitute one or more of the resonators in the stacked resonator circuit with a capacitor. The introduction of the capacitor can reduce the non-linearity of the received signals. In some cases, the capacitor may be a metal-insulator-metal (MIM) capacitor. Advantageously, the combination of the stacked resonators and the capacitor substitution for a resonator improves the linearity of the antennaplexer and provides for sharper rejection of undesired signals. Thus, the wireless device can support a greater number of frequency bands and/or frequency bands that are more likely to cause harmonic interference and/or IMD distortion. In some cases, the harmonic interference or IMD interference may be reduced by up to 15 dB compared to existing filters or antennaplexers.

The resonators used herein may be acoustic wave resonators or acoustic wave filters. An acoustic wave resonator including any suitable combination of features disclosed herein can be included in a filter arranged to filter a radio frequency signal in a fifth generation (5G) New Radio (NR) operating band within Frequency Range 1 (FR1). A filter arranged to filter a radio frequency signal in a 5G NR operating band can include one or more acoustic wave resonators disclosed herein. FR1 can be from 410 MHz to 7.125 GHz, for example, as specified in a current 5G NR specification. One or more acoustic wave resonators in accordance with any suitable principles and advantages disclosed herein can be included in a filter arranged to filter a radio frequency signal in a fourth generation (4G) Long Term Evolution (LTE) operating band and/or in a filter with a passband that spans a 4G LTE operating band and a 5G NR operating band. As an additional example, one or more acoustic wave resonators in accordance with any suitable principles and advantages disclosed herein can be included in a filter arranged to filter a radio frequency signal in a global positioning system (GPS) receiver.

Much of the present disclosure relates to reducing interference that may affect the ability of a receiver to receive or distinguish signals from other signals. For example, the antennaplexer herein may receive or distinguish GPS signals from other signals to provide to a GPA receiver. It should be understood that the present disclosure may be applied to other receivers and is not limited to GPS receivers. For example, aspects of the present disclosure may be applied to Wi-Fi receivers, 4G receivers, 5G receivers, and the like. Further, many of the examples described herein related to a GPS L1 triplexer. But the present disclosure is not limited as such, and aspects disclosed herein can be applied to any frequency band filter using acoustic resonators.

### Example Wireless Device

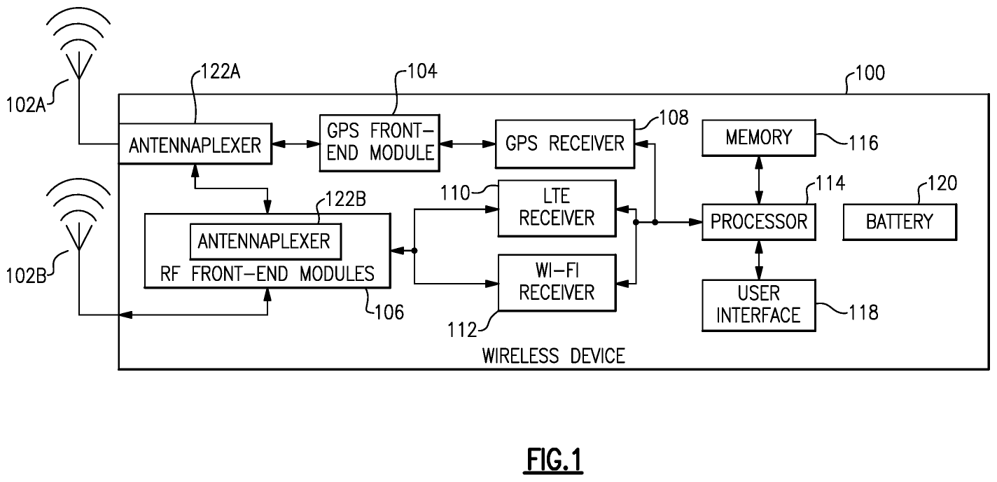

FIG. 1 illustrates a block diagram of an aspect of a wireless device 100. The wireless device 100 may include any type of wireless device that is configured to receive wireless signals. In some cases, the wireless device 100 may include any type of wireless devices capable of processing a plurality of wireless signals using a plurality of technologies, communication standards, or features of the wireless device 100. For example, the wireless device 100 may be a cellular phone (including a smart phone or a dumb phone), a tablet device, a laptop, a smartwatch, a pair of smart glasses, or any other wearable device, internet-of-things (IOT) device, or computing device that may include wireless capability.

The example illustrated in FIG. 1 is of a wireless device that includes the capability of receiving a GPS signal, a Wi-Fi signal, and a 4G LTE signal. However, the wireless device 100 is not limited as such and may include wireless devices that are capable of receiving and/or processing fewer or greater numbers of wireless signals, or other types of wireless signals. For example, the wireless device 100 may be capable of receiving Bluetooth® signals, 5G signals, near-field communication (NFC) signals, and the like.

The wireless device 100 may include one or more antennas 102A, 102B (which may be referred to in the singular as antenna 102 or collectively as antennas 102). The antennas 102 may be configured to receive one or more signals of one or more different frequencies or frequency bands. For example, the antennas 102 may receive signals having frequencies associated with GPS (e.g., 1.575 GHz), Wi-Fi (e.g., 2.4 GHz), or cellular communication (e.g., 800 MHz). It should be understood that any particular antenna 102 may be configured to receive signals of a plurality of different frequency bands. For example, the antenna 102A may be configured to receive any of the signals in the aforementioned example (e.g., signals from between 800 MHz to 2.4 GHz).

Signals received at the antennas 102 may be provided to one or more front-end modules within the wireless device 100. The wireless device 100 may include a GPS front-end module 104 and one or more additional RF front-end modules 106. It should be understood that the GPS front-end module 104 may also be an RF front-end module in that GPS signals are within the radio frequency band.

In some aspects of the wireless device 100, the signals received at the antennas 102 may be provided to an antennaplexer 122A, 122B (which may be referred to in the singular as antennaplexer 122 or collectively as antennaplexers 122). The antennaplexers 122 may direct a received signal to a particular front-end module 104, 106 and/or to a particular receiver 108, 110, 112. The antennaplexers 122 may include one or more filters that cause the antennaplexer 122 to direct the received signals from the antenna to the particular front-end module 104, 106 and/or to a particular receiver 108, 110, 112. In some cases, the filters of the antennaplexers 122 include band-pass filtering that permits a desired frequency band to be communicated to the front-end module and/or receiver. Further, the filters of the antennaplexers 122 may prevent or reduce harmonic frequencies, noise, or IMD interference.

As illustrated in FIG. 1 by the antennaplexer 122A, in some cases, the antennaplexer may be a separate circuit element that is positioned between the antenna 102 and the front-end modules 104, 106. In such cases, the antennaplexer 122A can direct a received signal to a particular front-end module 104, 106 based on the frequency band of the received signal. In other cases, as illustrated by the antennaplexer 1228, the antennaplexer may be included in a front-end module, and can direct a signal to a particular receiver 110, 112 based on the frequency band of the received signal. In certain aspects, the configuration of the resonators and/or filters within the antennaplexer 122 may be responsible for the directing of signals of particular frequency bands along particular transmission paths or to particular front-end modules or receivers.

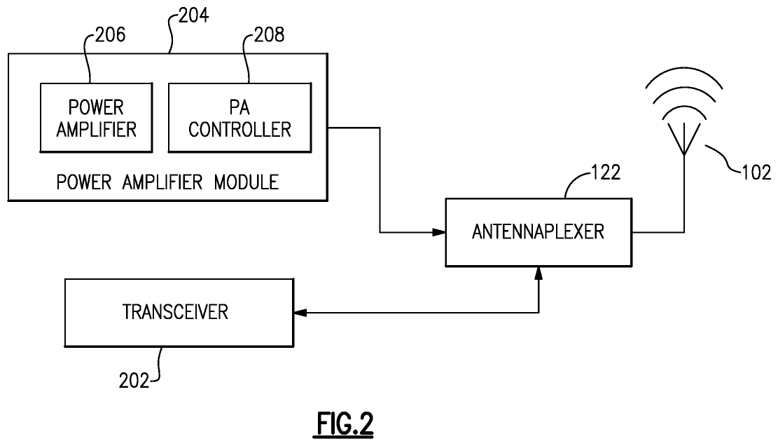

FIG. 2 illustrates a block diagram of some additional configurations of the wireless device 100 with an antennaplexer 122. As illustrated, the antennaplexer 122 (which may be an acoustic filter) may be connected to an antenna 102 from which the antennaplexer 122 may receive signals of one or more different frequencies. Further, the antennaplexer 122 may transmit signals of one or more frequencies via the antenna 102. The antennaplexer 122 may be in communication with one or more transceivers 202, such as one or more cellular transceivers (e.g., 3G, 4G, 4G LTE, or 5G transceivers), a GPS receiver, or a Wi-Fi® transceiver. Alternatively, or in addition, the antennaplexer 122 may be in communication with one or more power amplifier modules 204. The power amplifier modules 204 may be included as part of a transceiver 202 or in a front-end module (not shown). The power amplifier module 204 may include one or more power amplifiers 206. Further, the power amplifier module 204 may include a power amplifier controller 208 that may set or adjust the configuration of the power amplifier 206 and/or the voltage supplied to the power amplifier 206.

Returning to FIG. 1, although multiple antennaplexers 122 are illustrated, it should be understood that the wireless device may include a single antennaplexer 122. The antennaplexer 122 may be configured to communicate with a single antenna and may direct signals of different frequency bands to different transceivers. Alternatively, the antennaplexer 122 may be configured to communicate with multiple antennas and may direct signals to different receivers from different antennas and/or to different antennas from different transmitters.

The GPS front-end module 104 may include any front-end module that is capable of processing signals within one or more GPS frequency bands. Further, the GPS front-end module 104 may include any type of front-end module that is capable of performing pre-filtering before providing a received signal to a receiver, such as the GPS receiver 108. As will be described in more detail below, the GPS front-end module 104 may include additional out-of-band filtering capability that reduces or prevents the occurrence of harmonic interference and/or intermodulation interference.

The RF front-end modules 106 may include one or more front-end modules that are capable of processing signals within one or more RF frequency bands. For example, the RF front-end modules 106 may include front-end modules capable of processing Wi-Fi signals or LTE cellular communication signals. In some embodiments, the RF front-end modules 106 may include similar capabilities as the GPS front-end module 104 enabling the reduction or prevention of the occurrence of harmonic interference and/or intermodulation interference within target frequency bands for the particular RF front-end modules 106. For example, for an RF front-end module 106 configured to process signals for LTE cellular communications, the RF front-end module 106 may be configured to reduce or prevent harmonic interference and/or intermodulation interference within one or more of the LTE cellular communication frequency bands.

The GPS front-end module may isolate, identify, or pass signals associated with a GPS frequency while reducing or blocking out-of-band signals not associated with GPS. The filtered GPS signals may be amplified using, for example, a low noise amplifier (LNA) in the GPS front-end module and then the amplified GPS signals may be provided to the GPS receiver 108. The GPS receiver 108 may include any type of receiver that can process the amplified GPS signals. The GPS receiver 108 may further filtered the amplified GPS signals. In addition, the GPS receiver 108 may include frequency down-conversion, such as via a demodulator, and may demodulate the signal received from the GPS front-end module 104. Further, the GPS receiver 108 may include analog-to-digital conversion that can convert the analog signal received from the GPS front-end module 104 to a digital signal, which may then be processed by the processor 114.

In some embodiments, the wireless device 100 may further include additional filters and/or amplifiers between the GPS front-end module 104 and the GPS receiver 108. Further, in some embodiments, the GPS receiver 108 may be part of a transceiver.

The wireless device 100 may further include one or more additional receivers configured to receive filtered and/or amplified signals from the one or more additional RF front-end modules 106. For example, the wireless device 100 includes an LTE receiver 110 capable of processing LTE signals and a Wi-Fi receiver 112 capable of processing Wi-Fi signals.

The receivers 108, 110, and 112 may each be in communication with the processor 114. The processor 114 may provide any suitable baseband processing functions for the wireless device 100. Further, the processor 114 may provide any general processing capability for the wireless device 100.

The front-end modules 104, 106 and/or the receivers 108, 110, 112 may include differential-based circuitry. For example, the front-end modules 104, 106 and/or the receivers 108, 110, 112 may include differential LNAs. One or more acoustic wave filters (e.g., SAW or BAW filters) may convert a received signal to a differential signal to provide to the LNAs.

The memory 116 can store any suitable data for the wireless device 100. Further, the memory 116 may include any type of memory including both volatile and non-volatile memory.

The user interface 118 may include any type of user interface capable of receiving user inputs and/or outputting data to a user. For example, the user interface 118 may include a display, a touchscreen, one or more interactive user interface devices (e.g., buttons, sliders, capacitive sensors, resistive sensors, and the like), or any other user interface elements.

The wireless device 100 may further include a battery 120 or other power source capable of powering the wireless device 100 and/or one or more elements of the wireless device 100. The battery 120 may include rechargeable batteries. Further, the battery 120 may include or be replaced by any other type of power supply system.

### Example Antennaplexer

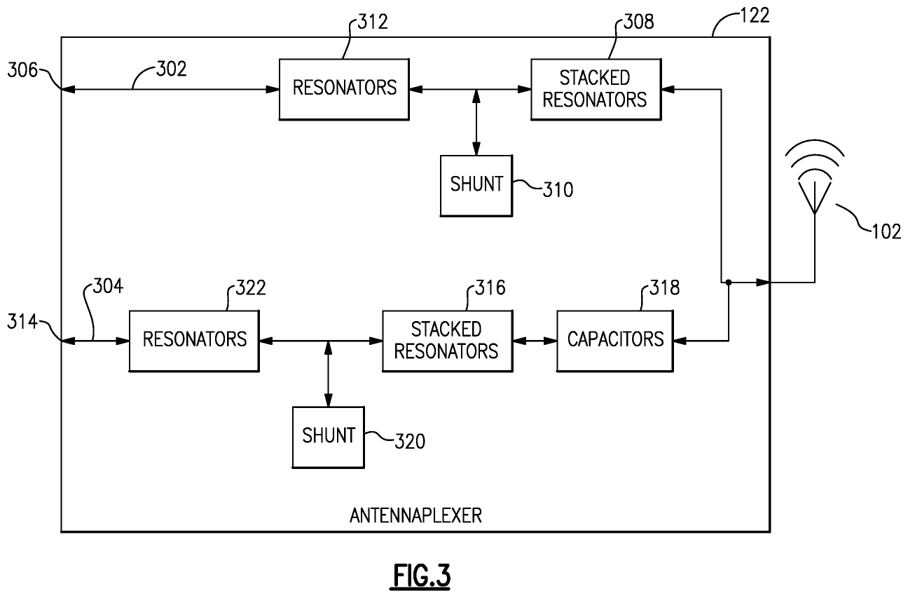

FIG. 3 illustrates a block diagram of an antennaplexer 122 in accordance with certain aspects of the present disclosure. It should be understood that the block diagram of FIG. 3 is one non-limiting example of the antennaplexer 122 and that other configurations of the antennaplexer 122 are possible. For example, the antennaplexer 122 may have different configurations based on the particular frequency bands and/or transceivers supported by the wireless device 100. For instance, if the wireless device supports three receivers and/or three frequency bands, the antennaplexer 122 may have a third transmission path within the antennaplexer 122 configured to support a third frequency band. Moreover, as will be explained further below, different transmission path or transmission line configurations may be used to support different frequency bands.

The antennaplexer 122 of FIG. 3 includes two transmission paths 302, 304. The first transmission path 302 is capable of receiving signals of a first frequency band from the antenna 102 and outputting them via a port 306 to a receiver. In some aspects, the antennaplexer 122 may receive signals of the first frequency band from the port 306 for transmission via the antenna 102. The first transmission path 302 may filter out signals not of the first frequency band. The filtering may not only reduce or eliminate signals of unsupported frequency bands, but may also reduce harmonic interference and/or IMD distortion or interference.

The first transmission path 302 may include a set of stacked resonators 308, a shunt 310, and optionally, one or more additional resonators 312. The use of resonators for filter components in place of an LC circuit may result in improved performance. However, the resonators may also introduce nonlinearities into the filters.

The number of resonators and the configuration of the resonators may be based on the desired frequency band. Further, the use of the stacked resonators enables a sharper rejection of undesired signals compared to traditional filters improving the rejection of the harmonic frequencies and/or the frequencies that cause IMD interference. By splitting the signal across the stacked resonators, the voltage may be reduced across each resonator generating less harmonic noise. Moreover, the voltage divider formed by the stacked resonators may reduce the non-linearity of the signal processed by the transmission path 302.

The second transmission path 304 is capable of receiving signals of a second frequency band from the antenna 102 and outputting them via a port 314 to a receiver. The receiver in communication with the port 314 may differ from the receiver in communication with the port 306. In some aspects, the antennaplexer 122 may receive signals of the second frequency band from the port 314 for transmission via the antenna 102. The second transmission path 302 may filter out signals not of the second frequency band, such as signals of the first frequency band that are processed via the first transmission path 302. Similarly, the first transmission path may filter out signal of the second frequency band. As stated above, the filtering may reduce or eliminate signals of unsupported frequency bands, and may also reduce harmonic interference and/or IMD distortion or interference.

The second transmission path 304 may include a set of stacked resonators 316 in series with one or more capacitors 318. In some implementations, the one or more capacitors may replace a resonator of the stacked resonators 316. By replacing a resonator in the stacked resonators 316 with a capacitor 318, the linearity of the applied signal may be improved. In other words, in some aspects, the non-linearity of the applied signal may be reduced. Generally, acoustic resonators have worse linearity than a capacitor. In certain aspects, by using a capacitor 318 to replace one of the stacked resonators, the total non-linearity created from stacked resonators may be reduced. For example, each resonator of a pair of stacked resonators may introduce some non-linearity. Replacing one of the resonators with a capacitor may eliminate the contribution of non-linearity by the resonator being replaced. In other words, only the remaining resonator from the pair of resonators will contribute to the total non-linearity. Moreover, in some cases, the stacked resonators 316 may be replaced with a single resonator stacked with a capacitor.

In some cases, because the capacitor 318 is stacked with the resonators 316, the size of each resonator included in the stacked resonators 316 may be increased compared to the size of the resonators without the stacked capacitor (e.g., compared to the stacked resonators 308). For example, in some cases, each resonator included in the stacked resonators 316 may be approximately 1.5 times the size of the resonators included in the stacked resonators 308. This increase in size may be when the stacked resonators 316 are stacked with a single capacitor. The stacking of additional capacitors with the stacked resonators 316 may further increase the size of each resonator. Increasing the size of the resonator may include increasing the area of the resonator. In cases with two stacked capacitors, the area of each resonator may be doubled. As another example, in implementations that use three stacked capacitors stacked with the resonators 316, each resonator may be tripled in area. Thus, in some cases, the improved linearity that may be obtained by replacing a resonator with a capacitor may have a trade-off of increased size for the antennaplexer.

Further, the second transmission path may include a shunt 320, and optionally, one or more additional resonators 322. The number of resonators and the configuration of the resonators, and the number and size of the capacitors 318 may be based on the desired frequency band. Further, the use of the stacked resonators in series with the capacitors enables a sharper rejection of undesired signals compared to traditional filters improving the rejection of the harmonic frequencies and/or the frequencies that cause IMD interference. Moreover, the substitution of a resonator with the capacitor provides a further reduction in non-linearity compared to traditional filters or the use of resonators alone.

It should be understood that one or more additional circuit elements may be included as part of the transmission paths 302, 304. For example, one or more resistors, inductors, or capacitors may be included to facilitate impedance matching or filtering of noise within the transmission paths. Further, as will be discussed in more detail below, the antennaplexer 122 may include one or more transmission paths or filters that are implemented using inductor-capacitor circuits instead of resonators.

### Example Antennaplexer Circuit

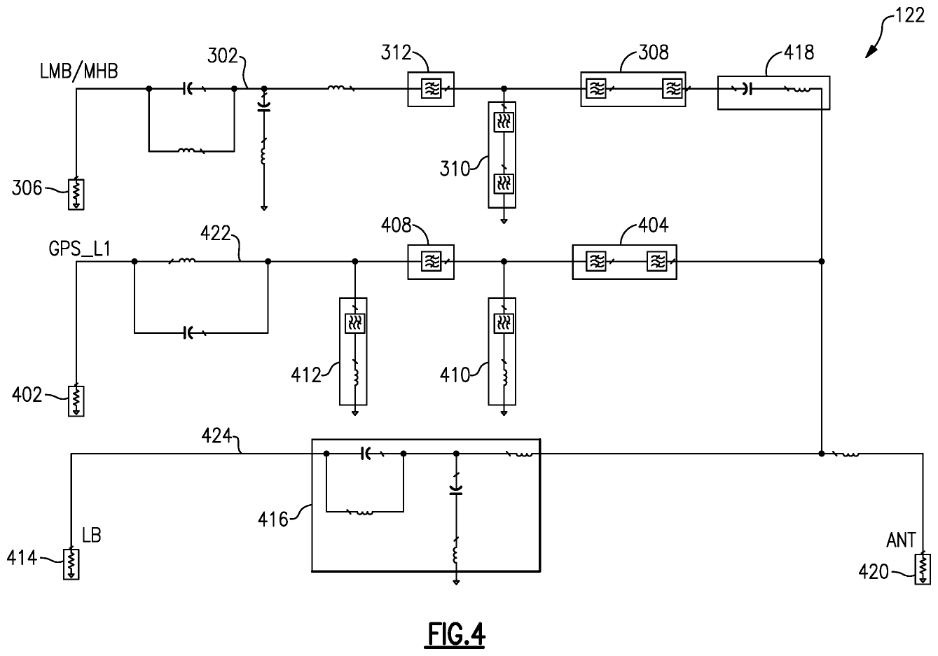

FIG. 4 illustrates a circuit diagram of an antennaplexer 122 in accordance with certain aspects of the present disclosure. As previously described, the antennaplexer 122 may be positioned between an antenna and one or more receivers or front-end modules. Thus, the antennaplexer 122 may have an antenna port 420 connected to an antenna, and a plurality of ports connected to one or more receivers, transmitters, or front-end modules. For example, the antennaplexer 122 of FIG. 4 may have a port 306 that connects to a receiver configured to process low mid-band or mid high-band (LMB/MHB) receive signals (e.g., frequencies between 1.5 to 2.2 GHz). As another example, the antennaplexer 122 may have a port 402 configured to connect to a GPS receiver configured to process the GPS L1 band centered around 1.575 GHz. In yet another example, the antennaplexer 122 may have a port 414 configured to connect to a low-band receiver configured to process low-band signals (e.g., frequencies below 0.95 GHz).

Each port may connect to a different transmission path 302, 422, 424 between the port and the antenna port 420. Each transmission path 302, 422, 424 may be configured as a filter configured to permit communication of signals of a particular frequency while blocking signals of other frequencies. For example, the transmission path 302 between the antenna port 420 and the LMB/MHB port 306 may permit signals associated with LMB/MHB frequencies (e.g., frequencies between 1.5 to 2.2 GHz) while blocking other frequencies. It should be understood that the filter of the transmission path 302 may be configured to permit more or less of the frequency band 1.5 to 2.2 GHz. The transmission path 422 may be configured to permit GPS frequencies (e.g., a frequency band centered around 1.575 GHz) while blocking other frequency bands. And the transmission path 424 may be configured to permit low-band frequencies (e.g., frequencies below 0.95 GHz) while blocking other frequencies. It should be understood that each of the transmission paths 302, 422, 424 may be configured to support different frequency bands than those of the above examples. Further, the antennaplexer 122 may include more or fewer transmission paths.

The transmission path 302 may include a filter implemented using a stacked resonator 308 on a main transmission path. Further, the filter may include a second stacked resonator in a shunt circuit 310 of the transmission path 302. As illustrated by the shunt circuits 410 and 412 of the transmission path 422, the shunt circuits may be implemented using a single resonator instead of a stacked resonator. The determination of whether to use stacked resonators or a single resonator may depend on the particular frequency band to be communicated and the desired rejection of harmonics and IMD distortion as well as the desired linearity of the signal to be communicated. Further, the configuration of the resonators may depend on the space available for the antennaplexer 122 within the wireless device 100.

Returning to the transmission path 302, the filter path may have one or more additional resonators 312 between the shunt circuit 310 and the port 306. In some implementations, the transmission path 302 may include an inductor-capacitor network or an inductor-capacitor circuit 418 between the antenna port 420 and the stacked resonator 308. This additional inductor-capacitor circuit 418 may create notches out of the passband, and help match the impedance to a target impedance, usually, but not necessarily 50 Ohms. Further, the transmission path 302 may have one or more additional inductor-capacitor circuits between the resonators and the port 306. These additional inductor-capacitor circuits may be used to facilitate impedance matching and/or to provide additional noise filtering within the receive signal. Each of the additional LC circuits illustrated in the transmission paths 302, 422, and 424 may be used to provide frequency rejection notches at designated frequencies within the corresponding transmission paths 302, 422, and 424. Although the stacked resonator 308 and the stacked resonator of the shunt circuit 310 are illustrated as a pair of resonators, it should be understood that the stacked resonators may include more than two resonators. By increasing the number of resonators stacked together, the harmonic rejection and the IMD rejection may be improved. Further, linearity may be improved. However, increasing the number of resonators may result in an increase in the size of each resonator. Thus, in some cases, it may be desirable to not add more than 2 or 3 resonators to prevent the antennaplexer 122 from using valuable space within the wireless device 100.

The transmission path 422 represents an alternative configuration to the transmission path 302 that is configured to support (e.g., communicate) different frequency bands than the transmission path 302. In other words, the antennaplexer 122 may function as a multiplexer permitting different frequencies to traverse different communication paths based on the configuration of the transmission paths. The transmission path includes a stacked resonator 404, which may include two or more resonators. As with the stacked resonator 308, more resonators may be stacked to improve the accuracy of the filter. However, the inclusion of additional resonators may, in some cases, expand the size of the filter. For example, in some cases, to maintain the transmission speed of the transmission path, it may be necessary to increase the area of each resonator for each additional resonator added to the stacked resonator circuit. Thus, in some cases, each resonator may increase in size for each additional resonator added to the stacked resonator circuit. For example, if a third resonator is added, the size of each resonator may be increased by about 1.5× in size or area so as to maintain the transmission speed of a signal through the transmission path.

The transmission path 422 may further include a pair of shunt circuits 410, 412 surrounding an additional resonator 408. Each of the shunt circuits 410, 412 may include a stacked resonator and/or a resonator-inductor circuit as illustrated in FIG. 4.

The transmission path 424 illustrates a non-resonator based filter path. The filter of the transmission path 424 may be an inductor-capacitor circuit (an LC circuit). In some cases, one or more of the supported frequency bands may be sufficiently distinct or separate from other supported frequency bands that the improved noise, harmonic, and IMD rejection is unnecessary. In such cases, a resonator-based filter path may be omitted and an LC circuit may be used for the filter as illustrated with the transmission path 424. As previously described, the LMB/MHB path may include frequencies between 1.5 to 2.2 GHz and the GPS path may include frequencies around 1.575 GHz. Accordingly, as the two paths may include frequencies that are relatively near to each other, an improved filter may be desired. However, as the LB filter path may be associated with frequencies that are not close to the other supported frequencies (e.g., less than 0.95 GHz), in some cases, it is unnecessary to have the improved noise, harmonic, and IMD rejection, and the use of an LC filter may be sufficient. In other cases, even when the supported frequency bands are not close in frequency, it may still be desirable to use a stacked resonator based filter because IM2 interference or harmonic noise may cause interference with a desired signal.

### Second Example Antennaplexer

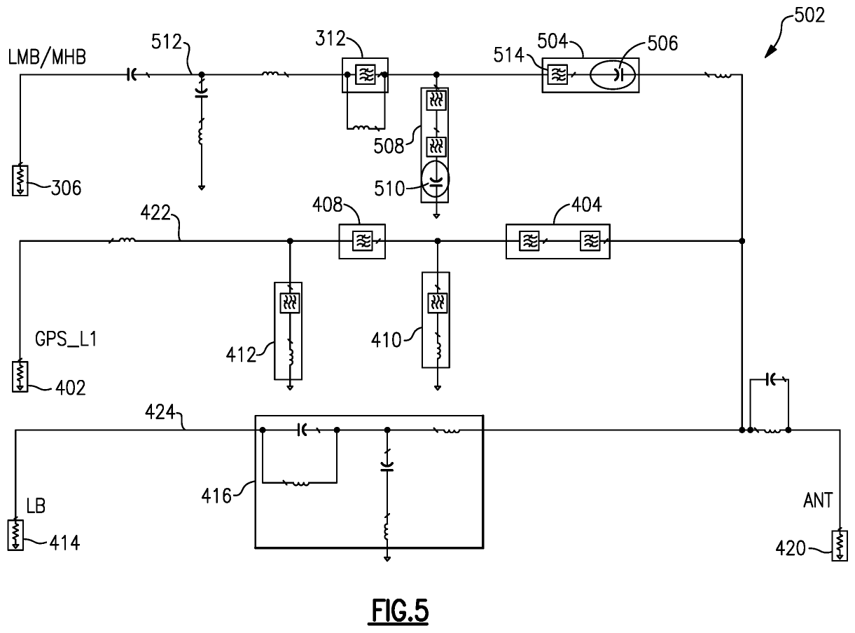

FIG. 5 illustrates a circuit diagram of an alternative antennaplexer 502 in accordance with certain aspects of the present disclosure. The antennaplexer 502 may include one or more of the features described with respect to the antennaplexer 122. For example, the antennaplexer 502 may include the transmission paths 422 and 424. Further, the antennaplexer 502 may include a transmission path 512 configured to permit communication or transmission of signals of a LMB/MHB frequency through the transmission path 512 while blocking other frequencies.

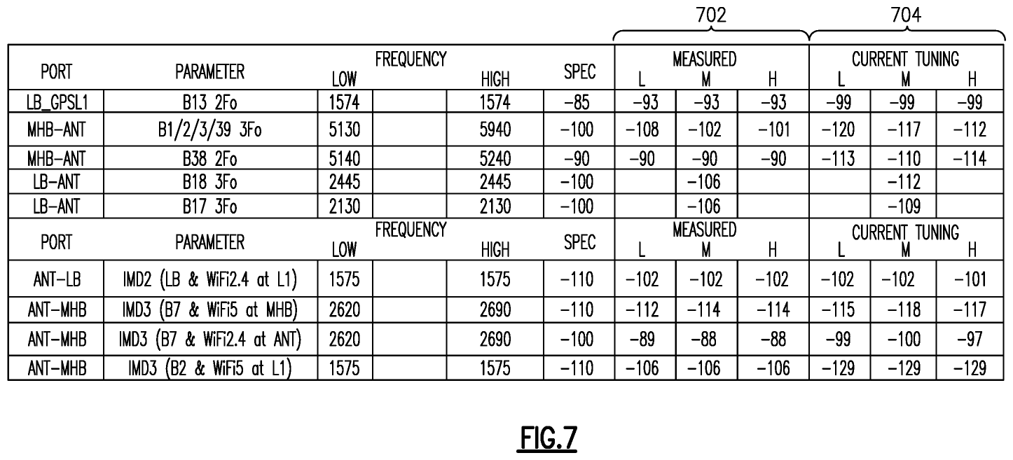

The transmission path 512 may include a resonator circuit 504. The resonator circuit 504 may include a resonator 514 stacked, or connected serially, with a capacitor 506 in place of a second resonator. Advantageously, in certain implementations, replacing a resonator with a capacitor in the resonator circuit 504 may result in improved harmonic and IMD rejection compared to an antennaplexer that uses stacked resonators and/or compared to antennaplexers that use LC filters instead of resonators. Improvement of the resonator-capacitor implementation over the stacked resonator implementation is demonstrated in the simulation results illustrated in FIGS. 7-9 discussed below. In some cases, the resonator circuit 504 may include stacked resonators in series with a capacitor 506. The capacitor 506 may substitute for an additional resonator that may be or may have been stacked with the stacked resonators but for the substitution of the capacitor 506. In other words, in one example, a stacked resonator that may originally have been designed or may have 3 resonators may instead be designed with 2 resonators and a capacitor 506.

Further, in some cases, a capacitor 510 may be added to the stacked resonators of the shunt circuit 508. In some cases, the capacitor 510 may replace or substitute for a resonator in the shunt circuit 508. Thus, the shunt circuit 508 may have a similar configuration to the series resonator circuit 504. Moreover, in some implementations, additional resonators 514 and/or capacitors 506 may be stacked to the resonator circuit 504. Similarly, additional resonators or capacitors 510 may be stacked to the shunt circuit 508. In certain cases, a designer of the antennaplexer, or an automated design computing system, may design the filter circuits using resonators to obtain the desired filtering (e.g., to permit and/or block the desired frequency bands). The designer may then split the resonators into stacks of 2, 3, or more resonators. One or more of the resonators may than be replaced with one or more capacitors of an equivalent size based on the equivalent capacitance. In certain implementations, substituting a capacitor 510 for a resonator in the shunt circuit 508, or adding a capacitor 510 to one or more resonators of the shunt circuit 508 may improve the harmonic and/or IMD rejection compared to an antennaplexer using LC filters or resonators without a series capacitor.

The capacitors 506, 510 may be metal-insulator-metal (MIM) capacitors. Alternatively, or in addition, other types of capacitors may be utilized for the capacitors 506, 510. For example, the capacitors 506, 510 can include any type of surface mounted capacitor, such as ceramic or electrolytic capacitors.

### Example Resonator

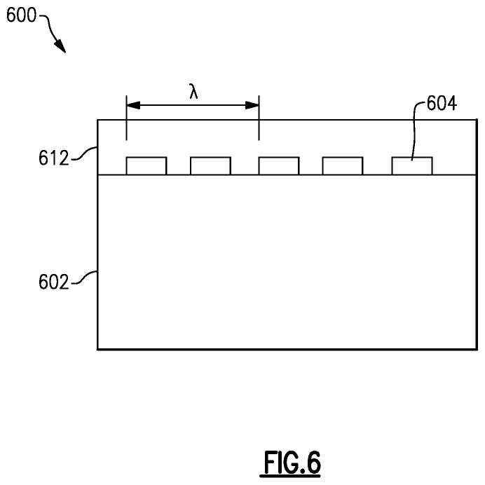

FIG. 6 is a diagram of a cross section of a temperature compensated SAW (TCSAW) resonator 600 according to certain aspects of the present disclosure. The TCSAW resonator 600 is one non-limiting example of a resonator that may be included in the stacked resonator circuits described herein (e.g., resonator circuits 308 or 504, etc.), or any of the other resonator circuits described herein, including in the various shunt circuits described herein (e.g., the shunt circuits 310, 410, or 508, etc.). In certain aspects, the resonators used in the circuits described herein may be other than TCSAW resonators. For example, the resonators may be non-temperature compensated SAW resonators. In other cases, the resonators may be surface acoustic wave (SAW) resonators, bulk acoustic wave (BAW) resonators, or thin-film bulk acoustic wave (FBAW) resonators.

The TCSAW resonator 600 is an example of an acoustic wave resonator that can have a relatively narrow IDT electrode aperture. The illustrated TCSAW resonator 600 includes a piezoelectric layer 602, an IDT electrode 604 on the piezoelectric layer 602, and a temperature compensation layer 612 over the IDT electrode 604. The piezoelectric layer 602 can be a lithium niobate substrate or a lithium tantalate substrate, for example. The IDT electrode 604 can have a relatively narrow aperture to concentrate a transverse spurious mode in frequency. The IDT electrode 604 can be implemented in accordance with any suitable principles and advantages of the IDT electrode with a narrow aperture disclosed herein. The TCSAW resonator 600 can be included as a series resonator in a filter to improve filter skirt steepness. The TCSAW resonator 600 can be included as a shunt resonator in a filter to improve filter skirt steepness.

The temperature compensation layer 612 can bring the temperature coefficient of frequency (TCF) of the TCSAW resonator 600 closer to zero relative to a similar SAW resonator without the temperature compensation layer 612. The temperature compensation layer 612 can have a positive TCF. This can compensate for the piezoelectric layer 602 having a negative TCF. The temperature compensation layer 612 can be a silicon dioxide (SiO₂) layer. The temperature compensation layer 612 can include any other suitable temperature compensating material including without limitation a tellurium dioxide (TeO₂) layer or a silicon oxyfluoride (SiOF layer). The temperature compensation layer 612 can include any suitable combination of SiO₂, TeO₂, and/or SiOF.

### Test Data

FIG. 7 presents test data comparing the antennaplexers 122 and 502 of FIG. 4 and FIG. 5. The top portion of the table in FIG. 7 compares the harmonic rejection between the antennaplexers 122 and 502 at different ports. The bottom portion of the table in FIG. 7 compares the reduction in second and third order IM distortion (IMD) between different pairs of frequencies at different ports of the antennaplexers 122 and 502.

The columns 702 present data obtained for the antennaplexer 122, which includes stacked resonators. The columns 702 include dBm data for low, medium, and high frequencies within the indicated frequency band. As illustrated, the antennaplexer 502 has improved harmonic rejection over the antennaplexer 122. For example, the antennaplexer 122 has a harmonic rejection of −93 dBm for the second harmonic of band 13. In contrast, the antennaplexer 502 has a −99 dBm harmonic rejection for the second harmonic of band 13.

The columns 704 present dBm data obtained for the antennaplexer 502, which substitutes a capacitor within the stacked resonator circuits. The columns 704 also include data for low, medium, and high frequencies within the indicated frequency band. In most cases, the antennaplexer 502 has improved IM distortion reduction compared to the antennaplexer 122. For example, while the IMD3 is reduced by −106 dBm with the antennaplexer 122, the reduction for the antennaplexer 502 is −129 dBm.

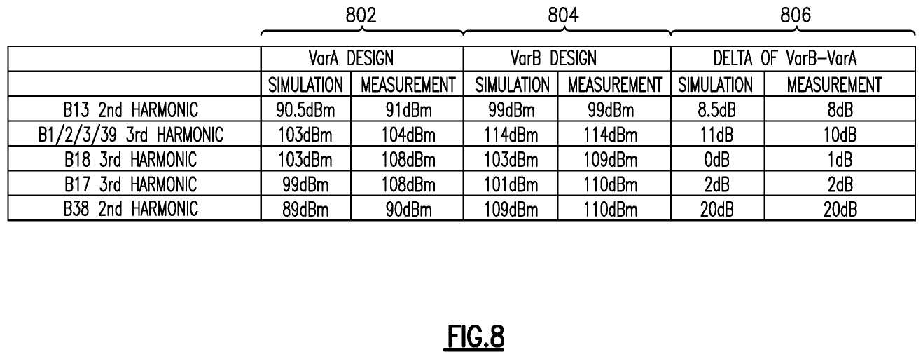

FIG. 8 presents both test data and simulation data comparing the harmonic rejection between the antennaplexers 122 and 502 of FIG. 4 and FIG. 5. The column 802 compares the difference between simulated data and measured data for harmonic rejection of the antennaplexer 122 for second and third harmonics of several frequency bands (e.g., bands 1, 2, 3, 13, etc.). Similarly, the column 804 compares the difference between simulated data and measured data for harmonic rejection of the antennaplexer 502. As illustrated by the columns 802 and 804, the data obtained during test of implementations of the antennaplexers 122 and 502 are similar to the simulated data. Further, the column 806 illustrates that a comparison of the harmonic rejection using the antennaplexer 502 is equal or better than the antennaplexer 122.

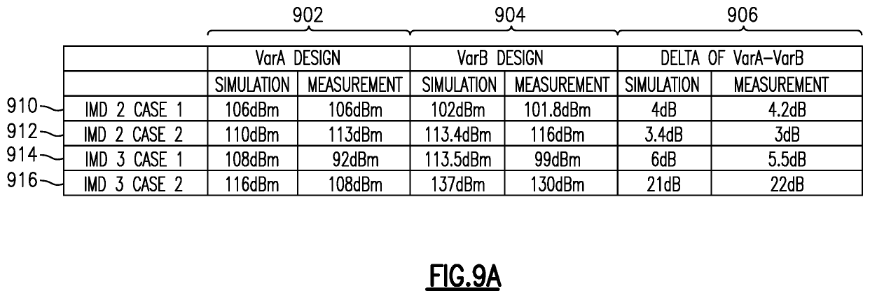

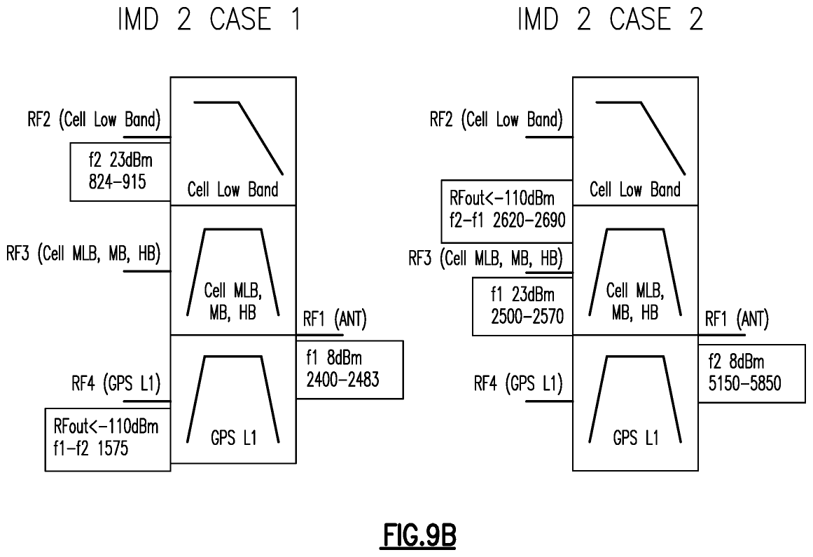

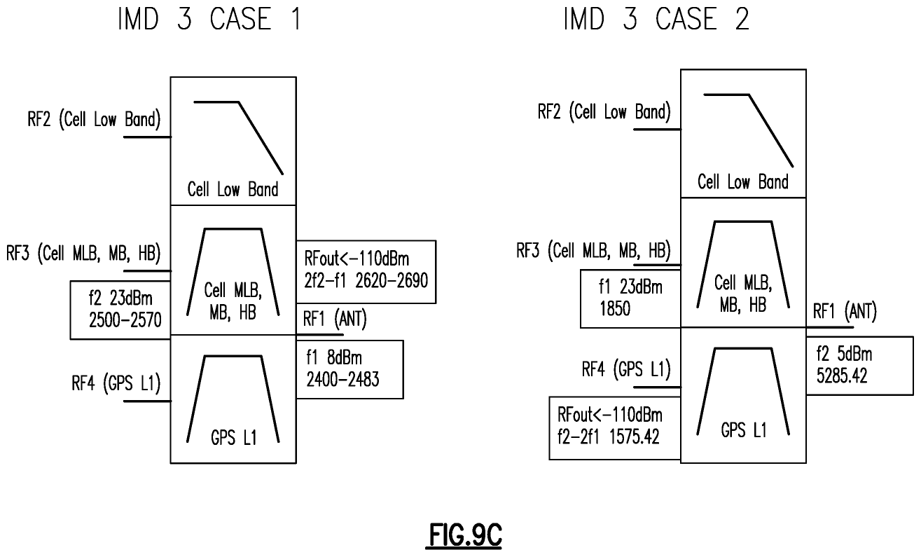

FIG. 9A presents both test data and simulation data comparing the intermodulation distortion reduction between the antennaplexers of FIG. 4 and FIG. 5. The column 902 presents for comparison simulated data and measured data for various cases (described below with respect to FIGS. 9B and 9C) of second and third-order intermodulation distortion for the antennaplexer 122. Similarly, the column 904 presents for comparison simulated data and measured data for the same various cases of second and third-order intermodulation distortion for the antennaplexer 502. As illustrated by the columns 902 and 904, the data obtained during test of implementations of the antennaplexers 122 and 502 are similar to the simulated data. Further, the column 906 illustrates that a comparison of the IM distortion reduction using the antennaplexer 502 is equal or better than the antennaplexer 122 in most, although not all, cases.

FIG. 9B illustrates a pair of example second-order intermodulation distortion cases used to generate the test data of FIG. 9A. The IMD2 Case 1 example use case was used to generate the test results in row 910 of FIG. 9A. The IMD2 Case 2 example use case was used to generate the test results in row 912 of FIG. 9A. In the IMD2 Case 1, a signal f1 with a frequency between 2400 and 2483 MHz is at the antenna port of the antennaplexer and a signal f2 with a frequency between 824 and 915 MHz is at the low band RF port (e.g., received from a low band power amplifier). The second-order intermodulation of the signal f1 and f2 is approximately 1575 MHz, which is similar to the GPS L1 signal band. However, as indicated in row 910 of FIG. 9A, the IMD rejection is between 101 and 106 dBm across the simulated and measured data for the antennaplexers 122 and 502.

In the IMD2 Case 2, a signal f1 with a frequency between 2500 and 2570 MHz is at the mid to high band RF port of the antennaplexer and a signal f2 with a frequency between 5150 and 5850 MHz is at the antenna port. The second-order intermodulation of the signal f1 and f2 is approximately between 2620 and 2690 MHz, which is close (e.g., less than 120 MHz difference) to the signal f1 and may, consequently, interfere with the signal f1. However, as indicated in row 912 of FIG. 9A, the IMD rejection is between 110 and 116 dBm across the simulated and measured data for the antennaplexers 122 and 502.

FIG. 9C illustrates a pair of example third-order intermodulation distortion cases used to generate the test data of FIG. 9A. The IMD3 Case 1 example use case was used to generate the test results in row 914 of FIG. 9A. The IMD3 Case 2 example use case was used to generate the test results in row 916 of FIG. 9A. In the IMD3 Case 1, a signal f1 with a frequency between 2400 and 2483 MHz is at the antenna port of the antennaplexer and a signal f2 with a frequency between 2500 and 2570 MHz is at the mid to high band RF port (e.g., received from a mid to high band power amplifier). The third-order intermodulation of the signal f1 and f2 is approximately between 2620 and 2690 MHz, which is close (e.g., less than a 100 MHz difference) to the f2 signal and may, consequently, interfere with the signal f2. However, as indicated in row 914 of FIG. 9A, the IMD rejection is between 92 and 113 dBm across the simulated and measured data for the antennaplexers 122 and 502.

In the IMD3 Case 2, a signal f1 with a frequency of 1850 MHz is at the mid to high band RF port of the antennaplexer and a signal f2 with a frequency of 5285.42 MHz is at the antenna port. The intermodulation of the signal f1 and f2 is approximately 1575.42 MHz, which is similar to the L1 GPS band and may, consequently, interfere with the L1 GPS band or may be misinterpreted as a GPS signal. However, as indicated in row 916 of FIG. 9A, the IMD rejection is between 108 and 137 dBm across the simulated and measured data for the antennaplexers 122 and 502. Thus, in each of the example uses cases that were both simulated and tested, the antennaplexers 122 and 502 were able to reject the harmonic and IMD interference. Moreover, the antennaplexer 502 was shown to have better performance in most cases over the antennaplexer 122.

### Terminology

Any of the embodiments described above can be implemented in association with mobile devices such as cellular handsets. The principles and advantages of the embodiments can be used for any systems or apparatus, such as any uplink wireless communication device, that could benefit from any of the embodiments described herein. The teachings herein are applicable to a variety of systems. Although this disclosure includes example embodiments, the teachings described herein can be applied to a variety of structures. Any of the principles and advantages discussed herein can be implemented in association with RF circuits configured to process signals having a frequency in a range from about 30 kHz to 300 GHz, such as in a frequency range from about 450 MHz to 8.5 GHz. Acoustic wave filters disclosed herein can filter RF signals at frequencies up to and including millimeter wave frequencies.

Aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators, filters, multiplexer, devices, modules, wireless communication devices, apparatus, methods, and systems described herein may be embodied in a variety of other forms. Furthermore, various omissions, substitutions and changes in the form of the resonators, filters, multiplexer, devices, modules, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. An antennaplexer comprising:
a first signal path between an antenna port and a first output port, the first signal path including a first resonator in series with a first capacitor;
a first shunt path connected to the first signal path between the first resonator and the first output port; and
a second signal path between the antenna port and a second output port, the first signal path configured to transmit signals of a first frequency band and the second signal path configured to transmit signals of a second frequency band that differs from the first frequency band.

2. The antennaplexer of claim 1 wherein the first capacitor substitutes for a second resonator.

3. The antennaplexer of claim 1 wherein the first capacitor is a metal-insulator-metal type capacitor.

4. The antennaplexer of claim 1 wherein the first shunt path includes a stacked resonator including a second resonator in series with a third resonator.

5. The antennaplexer of claim 4 wherein the first shunt path further includes a second capacitor in series with the stacked resonator.

6. The antennaplexer of claim 5 wherein the second capacitor substitutes for a fourth resonator in series with the stacked resonator.

7. The antennaplexer of claim 1 wherein the first signal path includes a second resonator between the first shunt path and the first output port.

8. The antennaplexer of claim 1 further comprising a second shunt path connected to the first signal path between a node where the first shunt path connects to the first signal path and the first output port.

9. The antennaplexer of claim 1 wherein the second signal path includes an inductor-capacitor network without a resonator.

10. The antennaplexer of claim 1 wherein the first resonator is an acoustic wave resonator.

11. The antennaplexer of claim 10 wherein the acoustic wave resonator is a temperature compensated surface acoustic wave device.

12. The antennaplexer of claim 1 wherein the second signal path includes a stacked resonator including a second resonator in series with a third resonator.

13. The antennaplexer of claim 12 further comprising a second shunt path connected to the second signal path between the stacked resonator and the second output port.

14. The antennaplexer of claim 13 wherein the second shunt path includes a third resonator in series with an inductor.

15. The antennaplexer of claim 12 further comprising a third shunt path connected to the second signal path between a node where the second shunt path connects to the second signal path and the second output port.

16. The antennaplexer of claim 1 wherein the first frequency band corresponds to a cellular communication band and the second frequency band corresponds to a global positioning system band.

17. A front-end module comprising:
a power amplifier module configured to amplify one or more radio frequency signals; and
an antennaplexer including a first signal path, a shunt path, and a second signal path, the first signal path between an antenna port and a first output port, and including a first resonator in series with a first capacitor, the first output port in communication with the power amplifier module, the shunt path between the first resonator and the first output port, and the second signal path between the antenna port and a second output port, the first signal path configured to transmit signals of a first frequency band and the second signal path configured to transmit signals of a second frequency band.

18. The front-end module of claim 17 wherein the first capacitor substitutes for a second resonator.

19. The front-end module of claim 17 wherein the shunt path includes a stacked resonator including a second resonator in series with a third resonator.

20. A wireless device comprising:
an antenna configured to transmit and receive radio frequency signals;
a transceiver; and
an antennaplexer between the antenna and the transceiver, the antennaplexer including a first signal path, a shunt path, and a second signal path, the first signal path between an antenna port connected to the antenna and a first output port connected to the transceiver, and the first signal path including a resonator in series with a first capacitor, the shunt path between the resonator and the first output port, and the second signal path between the antenna port and a second output port, the first signal path configured to transmit signals of a first frequency band and the second signal path configured to transmit signals of a second frequency band.
